(19) United States
(12) Patent Application Publication
(10) Pub. No.: US 2008/0171537 A1
(43) Pub. Date: Jul. 17, 2008

(54) Method of providing voice stock information via mobile apparatus

(76) Inventor: Hung-Che Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,218

(22) Filed: Jan. 16, 2007

(51) Int. Cl. H04Q 7/22

(52) U.S. Cl. 455/412.2

(57) ABSTRACT

In a method of providing voice stock information via mobile apparatus, character codes of real-time stock information are translated into sound codes and transmitted to a mobile apparatus adapted to receive real-time stock information, so that stock information may be broadcasted at the mobile apparatus in voice. The method uses the data band of the wireless local area network or the Bearer as the transmission channel, so that the mobile apparatus may use the same one transmission channel to receive and display real-time stock information, as well as transmit sound codes without the need of using the conventional voice band as a transmission medium.

### FIELD OF THE INVENTION

The present invention relates to a method of providing voice stock information via mobile apparatus. In implementing the method, there is a receiving end in the form of a mobile receiving apparatus, and a server end in the form of a stock information computer system. At the server end, there is provided an HTTP server module, which is connected via the Ethernet or a wide area network (WAN) to the existing GGSN (Gateway of Global Service Network) of a bearer (mobile data network), such as a remote GPRS (General Packet Radio Service) or CDMA (Code Division Multiple Access), for the mobile apparatus at the receiving end, such as different user end apparatus, including a cell phone, a PDA (Personal Digital Assistant), etc., to receive modules and data required to translate the real-time text stock information into voice stock information for broadcasting at the mobile apparatus.

### BACKGROUND OF THE INVENTION

Most of the currently available mobile apparatus support the programmable software developing environments, such as the J2ME JAVA virtual machine, the WAP micro-browser, or the embedded operating system. And, most of the currently available cell phones and PDA's include a wireless transmission mechanism. Therefore, the transmission of real-time stock information to a mobile apparatus via a wireless communication system, such as GPRS or CDMA, is a workable and very popular value-added service for mobile apparatus users. While the real-time stock information may be displayed on the existing mobile apparatus, such information could not be vocally broadcasted via the mobile apparatus. Such a restriction obviously brings inconveniences to some users. For example, a user having visual problem would be unable to read the real-time stock information and a user in moving, such as driving a car, is unable to watch the mobile apparatus all the time. Therefore, it is desirable to provide a system architecture that provides not only the function of displaying real-time stock information, but also the function of vocally broadcasting the real-time stock information to thereby effectively eliminate the inconveniences in obtaining real-time text stock information via the conventional mobile apparatus.

Currently, the ways usually used to inquire the stock information via a mobile apparatus include IVR (Interactive Voice Response), JAVA, WAP (Wireless Application Protocol), the less used SMS (Short Message Service) and MMS, and so on. And, the presentation of the above-mentioned stock information may be divided into two types, namely, pure voice broadcasting (such as IVR) and pure graph and text displaying (such as JAVA and WAP). In a broad sense, the portable mobile apparatus for receiving stock information through wireless remote transmission further includes pager and DAB (digital radio).

The conventional pure voice broadcasting system (that is, IVR) has the following disadvantages:
1. The information does not last long. This is because the user fails to completely remember all the vocally broadcasted messages or to control the most important information, particularly when the messages are very long or there are too many messages. The user has to repeatedly listen the broadcasting.
2. Slow response. It requires longer time in the pure vocal broadcasting to provide the stock information, particularly when there is a large quantity of real-time stock information.
3. Line busy. When a cell phone is used to listen in to the broadcasted information, it is impossible to use same the cell phone to receive other incoming calls at the same time. In the event the user disconnects the vocal broadcasting system to answer the incoming call, and dials the vocal broadcasting system again after hanging up the phone, the user would have to listen into the broadcasted information from the very beginning thereof, which had been listened earlier.
4. High call cost. Presently, the cost of call via a cell phone is still high. The connection of the mobile apparatus to the vocal broadcasting system over a long time would incur a considerably high call cost. As a matter of fact, a very large part of the messages received in the whole connected period is not what needed by the user.
5. Limited ways of presentation. There are many important information, such as trend curve, various tables, etc., that could not be presented through the pure voice broadcasting.
6. Limited number of available connecting lines. Presently, due to the cost factor of system hardware, the voice broadcasting system is not able to provide effective services through further expanded number of connecting lines. Before a user disconnects the connecting line, the same line could not be used to provide services to other users. Users might not be able to listen in to the broadcasted information when the number of users is large and the available lines are insufficient.

On the other hand, the pure graph and text displaying systems (JAVA, WAP) have the following disadvantages:
1. The user has to watch the screen all the time. The currently available mobile apparatus is able to display the real-time stock information. However, the user could not get the information if he or she does not watch the screen of the mobile apparatus. For users who are not able to watch the screen over a long time, such as users with visual difficulty or users in driving, this is apparently a big restriction.
2. Small screen. Most of the currently available cell phones have a relatively small screen that is inconvenient for reading information displayed thereon.

Further, most of the conventional portable mobile apparatus have shortcomings in terms of transmitting information. When the conventional pager is used to receive remote stock information, stock digital data or encoded voice data is transmitted via the Flex pager system. Since the encoded-voice data would occupy a very large band capacity and accordingly requires quite a long time to transmit, it is not proper to directly transmit the voice data. And, in the case of character data transmitted to the pager, the user still has to watch or visually check the transmitted text to obtain the required information. In brief, it is impossible for the user to enjoy the convenience of what you hear is what you get. Besides, information or data might be delayed or lose due to interference by man-made or other factors, such as being unable to watch the pager all the time, resulting in missing the timing of trading. Investors might fail to control potential risk due to such problems.

In the digital audio broadcasting, full-range digital technology is employed to process sound signals in the broadcasting, and to reproduce the true sound of the digitalized sound signals in the process of transmission. That is, unlike the conventional analogue signal, the digitalized sound signals are not subject to distortion due to various interferences in the process of transmission. However, the digital audio broadcasting technique is still incomplete when it is applied to the broadcasting of stock information. This is because a large quantity of data is transmitted as a whole via one-way broadcasting. The user is not allowed to screen or select in advance the required information. Therefore, when the user is forced to receive all the stock information, it is very possible that the user could not get the real-time information and loses the good chance of trading, and fails to control the potential risk in investment.

### SUMMARY OF THE INVENTION

A primary object of the present invention is to provide a method in which a mobile voice stock information broadcasting system is used to efficiently transmit rich stock information in a mobile environment having very limited system resource through a simplified transmission manner. Unlike the conventional telephone voice connection, in the present invention, the transmission of a low bit-rate mono-sound code sequence replaces the conventional transmission of high volume of compressed audio data, so as to receive and playback real-time voice stock information, allowing a mobile apparatus user to quickly obtain the real-time stock information.

Another object of the present invention is to provide a voice translating module that translates information or data into word character codes, mono-sound code, and mono-sound code sequence in different stages to thereby largely reduce the bit rate of data transmission.

A further object of the present invention is to provide a playback module at a mobile apparatus end, so that any received data of stock information could be not only displayed in graph and text on a liquid crystal panel (such as STN or TFT LCD) built in the mobile apparatus, but also reduced to analogue signal via an A/D converter built in the mobile apparatus to drive the line out of a speaker or an earphone.

A still further object of the present invention is to provide an HTTP server module, so that stock codes, trigger conditions, etc. may be remotely selected or designated from the user end, and only the information or data meeting the designated stock codes and trigger conditions (such as changes in price and quantity, notice about price, and broadcasted messages) is transmitted to the mobile apparatus at the user end. That is, the present invention provides an AOD (Audio on Demand) function and it is not necessary to transmit and receive the whole stock information.

To adapt to the differences among the mobile apparatus at user end, the present invention uses the standard HTTP 1.1 established by W3C Forum as its basic transmission platform to achieve the compatibility at the transport layer.

The present invention uses the architectural model of distribution computing system to develop different types of binary voice receiving and playback modules, including Java Midlet (J2ME Specification), WML Script (WAP Specification), ActiveX (Microsoft Common Object Module Specification), WABA, Brew (Qualcom Specification), to provide the platform compatibility among different application layers.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a system architecture diagram of the present invention; and

FIG. 2 is a flowchart showing the procedures included in the present invention.

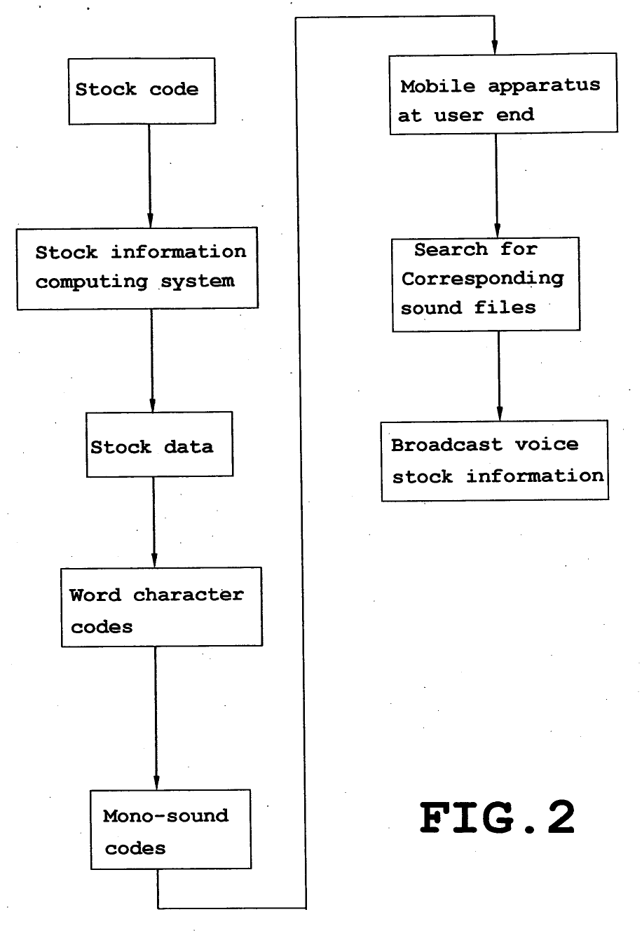

### DETAILED DESCRIPTION OF THE PREFERRED EMBODIMENTS

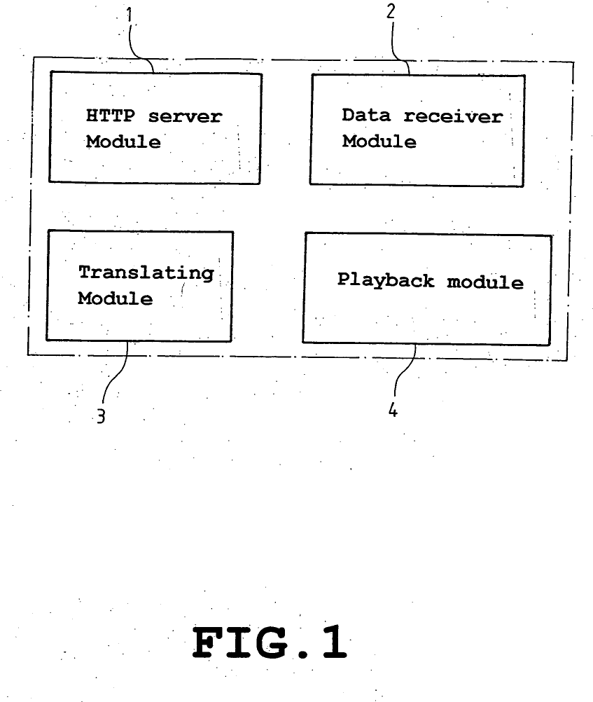

Please refer to FIG. 1. The present invention is divided into four major modules, namely, an HTTP server module 1, a data receiver module 2, a translating module 3, and a playback module 4.

The HTTP server module 1 is provided at a server end, that is, a stock information computing system, and is built based on the standard HTTP 1.1 established by W3C Forum to provide modules required by the mobile apparatus end, download a mono-sound file wordbank, and transmit real-time stock information and a mono-sound code sequence. The modules required by the mobile apparatus end include the data receiver module 2 and the playback module 4. When a user of a mobile apparatus is remotely connected to the stock information computing system for the first time, the HTTP server module 1 would follow the standard HTTP 1.1 to download the modules required by the mobile apparatus end and the mono-sound file wordbank, and install the downloaded modules and wordbank on the mobile apparatus to complete the standard install procedure in an OTA (over the air) mode. Wherein, the mono-sound file wordbank is downloaded by downloading one single sound file each time, so as to overcome the problem of reduced transmission rate in a moving state as would occur in the bearer, which is based on time-division multiplex (OFDM) encoding technique. In the event the connection of the mobile apparatus to the server end is poor, the transmission of all the mono-sound files at one time t ends to result in an invalid transmission. Therefore, a separate download mechanism is adopted for the purpose of managing the downloading of sound files.

When the data receiver module 2 downloaded to the mobile apparatus end has been successfully installed, it is automatically connected to the HTTP server module 1 and follows the user designated stock code to request the HTTP server module 1 to download the real-time stock data of the designated stock code. Each real-time stock data has a coding length being controlled to be within 1496 bytes, in order to comply with the Hamming code design principle for TCP packet, and to reduce the invalid transmission possibly occurred in a moving state. The stock data received by the data receiver module 2 may be presented in two ways. In the first way, the received stock data is shown on a small-size liquid crystal panel (STN or TFT LCD) built in the general mobile apparatus, and the data receiver module 2 provides mobile value-added services compatible with the currently very popular transmission of real-time stock information to the mobile apparatus. In the second way, the received mono-sound code sequence is searched for mono-sound files corresponding to the codes, and the mono-sound files are reduced to analogue signals by an A/D converter built in the mobile apparatus to thereby drive the line out of a speaker or an earphone.

The translating module 3 provided at the stock information computing system at the server end translates, in different stages, the stock data to be broadcasted into smooth word character codes and mono-sound codes, and then forms a mono-sound code sequence for broadcasting in a complete sentence. The HTTP server module 1 at the server end is connected to the mobile apparatus via the GGSN connection interface of the bearer, such as GPRS or CDMA, to receive user controlled and designated stock codes, and reads data of the designated stock code stored in the real-time price databank in the character code format via the remote stock information computing system. The read stock data is then translated in two stages. In the first stage, the read stock data is translated into corresponding word character codes; and in the second stage, phonetic-alphabet-based mono-sound codes are located according to the character codes to form the mono-sound code sequence for broadcasting in a complete sentence.

The translating module 3 includes an interface that actively reports back based on user-designated trigger conditions. A user may control and designate his trigger conditions. When the designated conditions exist, related voice information will be actively reported to the user's cell phone or other mobile apparatus for playback. The trigger conditions may include, for example, changes in stock price and quantity, notice of current price, broadcasted messages, and soon. Through designating trigger conditions, the system at the server end will actively produce a mono-sound code sequence and transmit the same to the user's cell phone or other mobile apparatus for broadcasting or playback.

The playback module 4 analyzes the mono-sound code sequence, and searches the mono-sound files wordbank for voice samples corresponding to individual mono-sound codes. The voice samples are downloaded and stored in a record management system (RMS) of the mobile apparatus when the playback module 4 is first downloaded and installed. The playback module 4 searches the RMS for mono-sound files corresponding to the codes, reads sound bit data, which is encoded in the PCM (pulse code modulation) format, in the files, and reduces the sound bit data to analogue signals via the A/D converter built in the mobile apparatus to thereby drive the line out of the speaker or the earphone on the mobile apparatus.

The present invention has a system architecture designed to integrate the above-mentioned four major modules to allow the existing mobile apparatus to provide not only the function of transmitting and displaying real-time stock information via the bearer, but also the function of transmitting and broadcasting voice information and data using the same data band and session. In the present invention, the stock information computing system is internally provided with the HTTP Server Module 1, which is connected via the Ethernet, a wide area network (WAN) interface to the GGSN (Gateway of Global Service Network) interface of a wireless local area network (WLAN), including 802.11a, 802.11b, and 802.11g, or a bearer, including but not limited to GSM, PDC, CDPD, CDMA, TDMA, PHS, DECT, GPRS, and 3G, for the mobile apparatus, such as a cell phone or a mobile digital personal assistant (PDA), to receive the real-time stock information. When a user is connected to the stock information computing system at the server end for the first time, the mono-sound file wordbank, the playback module 4, and the data receiver module 2 are downloaded via the HTTP server module 1 to reside in the flash memory of the mobile apparatus.

Thereafter, the HTTP server module 1 at the server end follows the stock code designated by the user to read the designated stock data, which is stored in a real-time price databank in character code format, from the remote stock information computing system, and the read stock data is translated in two stages by the voice translating module 3 in the computing system. In the first stage, the read stock data is translated into corresponding word character codes; and in the second stage, phonetic-alphabet-based mono-sound codes are located according to the character codes to form the mono-sound code sequence. The mono-sound code sequence is downloaded to the user's mobile apparatus via the HTTP server module 1. The playback module 4 searches the mono-sound file wordbank for corresponding sound files, and broadcasts the sound data stored in the sound files and existed in PCM format.

The translating module 3 is provided at the server end in the remote stock information computing system, instead of being provided in the hand-held mobile apparatus having lower operating ability, so as to largely improve the translating efficiency. Further, with the client-server architecture, it is possible to translate any real-time stock data one time for more than one user to connect to the server at the same time to conveniently share the information. This is one of the characteristics of the present invention.

In the nowadays mobile operating era, various kinds of consumptive electronic products, including smart phone, wireless network phone (Wi-Fi phone), PDA, automobile navigational system (TeleMatrics), etc., and all hand-held mobile apparatus must have not only the ability of mobile communication within the data band, but also the ability of supporting programmable application layer developing environments, such as J2ME JAVA virtual machine, WAP micro-browser, or embedded operating system, so that the mobile apparatus users may enjoy different mobile value-added services. Among the diversified apparatus specifications and software and hardware conditions for the various consumptive electronic products and the hand-held mobile apparatus, the transport layer and the application layer and the memory storage capacity form the major distinction among these different apparatus specifications and have significant influence on the mobile value-added services derived from them. Therefore, it is frequently found that apparatus of different specifications could not use mobile value-added services developed for some particular apparatus specifications.

To provide the largest possible support and convenience in use to different apparatus at the user end, and to ensure the compatibility of the cross platform apparatuses, the present invention adopts the standard HTTP 1.1 communication protocol established by W3C Forum as the basic transmission platform to achieve the compatibility of the transport layer. Moreover, the present invention uses the architectural model of distribution computing system to develop different types of binary voice receiving and playback modules, including Java Midlet (J2ME Specification), WML Script (WAP Specification), ActiveX (Microsoft Common Object Module Specification), WABA, Brew (Qualcom Specification), to provide the platform compatibility among different application layers. When the user apparatus is connected to the HTTP server module 1 in the stock information computing system at the server end for the first time, the HTTP server module 1 would obtain the type of the application layer and the version serial number of the user's apparatus via the User-Agent tag field in the standard header of the HTTP 1.1. This smart mechanism automatically prompts the user to download the playback module 4 corresponding to the application layer of the user's apparatus. Alternatively, a proper type of module may be selected and downloaded according to the user's selection instruction.

In addition to the above-mentioned function of ensuring the compatibility at the transport and the application layer among different types of mobile apparatus, the present invention also provides optimum design for hardware of different storage capacity. The present invention enables downloading of a concise version of mono-sound file wordbank for mobile apparatus with a small storage capacity or without expanded memory. If the user' s mobile apparatus has a high storage capacity, the present invention would then enables downloading of a complete version of mono-sound file wordbank. In this manner, it is possible to fully utilize the hardware storage capacity of different apparatus to thereby achieve the function of the present invention to enable the largest possible portability of the mobile apparatus. Taking Chinese as an example, based on the existing frequently used 1203 Chinese word sounds and the 10 digits and the 26 English letters, totaling 1239 words, a complete version mono-sound files would generally require a storage space about 1.5M. That is, when it is desired to broadcast all the possible mono-sound combinations, a storage space of about 1.5M is required. However, in the case of concise version stock data broadcasting, no more than forty sound files are needed, such as digits 0-9, rising, falling, current price, etc. That is, it is necessary to adopt a proper mechanism according to the actual need in broadcasting to avoid the undesirable condition of a useless apparatus or being unable to broadcast the information. The present invention is characterized in a smart mechanism that provides a suitable version of mono-sound file wordbank depending on the type of a mobile apparatus.

In the present invention, the stock information computing system has a complete version of mono-sound wordbank storing a predetermined number of word sounds and built in a relational databank management system (RDBMS). Presently, the number of all frequently used word mono-sound is from 1000 to 2000 at the best. It is possible to encode these characters using three bytes (hexadecimal transparent code). That is, the stock data for broadcasting is so encoded that three bytes correspond to an independent mono-sound, which also form the index values for the mono-sound file wordbank. The mono-sounds for the terms most frequently used in the stock market are coded and filed at a front section of the RDBMS, and the mono-sounds are coded in the combining sequence of the phonetic alphabets. This is the concise version of the sound files. The concise version of the sound files forms the basic sound files in the voice broadcasting of stock information according to the present invention, and is downloaded via the HTTP server module 1 when the user's mobile apparatus is first connected to the stock information computing system, no matter what platform is adopted by the mobile apparatus at the user end. The HTTP server module 1 always automatically downloads the concise version of mono-sound file wordbank. The complete version of sound file wordbank is located at a rear section of the RDBMS and is downloaded and installed depending on the user's control and decision.

The concise version of sound file wordbank built in the stock information computing system is further divided into two versions, namely, Mandarin and Taiwanese versions for Chinese language system, or official language and dialect language for other language systems. A user may control and decide whether to download one of three major versions of sound file wordbank, namely, the concise version sound file for Mandarin (or official language), the concise version sound file for Taiwanese (or dialect language), or the complete version sound file. As having been mentioned above, to download any one of the three versions of wordbank, the user may sequentially download the individual sound files via the HTTP server module 1. The downloaded mono-sound files are stored in the RMS (Record Management System) in the mobile apparatus, and the downloaded index values are automatically recorded. In the event the transmission is interrupted for any reason and the mobile apparatus is connected to the server end again, it is possible to continue the download from the index value at the point of interruption, so as to save the time needed to download the information and reduce the cost of transmission.

Thereafter, the HTTP server module 1 at the server end follows the stock code designated by the user to read the stock data, which is stored in the real-time price databank in the character code format, via the remote stock information computing system, and the read stock data is translated in two stages by the translating module 3 in the stock information computing system. In the first stage, the read stock data is translated into word character codes corresponding to Chinese or any other language system; and in the second stage, phonetic-alphabet-based mono-sound codes are located according to the character codes to form the mono-sound code sequence. The mono-sound code sequence is downloaded to the user's mobile apparatus via the HTTP server module 1, and the playback module 4 searches the mono-sound file wordbank for corresponding sound files and broadcasts the voice data that is stored in the sound files in the PCM format.

The following table shows an example of translating English alphanumeric stock information into English-based phonetic alphabets:

| | |
|---|---|
| Original Text | 1234 Microsoft |
| | Current Price 43.6 |
| | Buy 43.6 |
| | Sell 43.7 |
| | Rising 0.3 |
| Convert | 1234 Microsoft |
| Alphanumeric | Current Price Forty-three point six |
| Data into Words | Buy Forty-three point six |
| | Sell Forty-three point seven |
| | Rising zero point three |
| Translate Words | 1234 maikro . . . |
| Into | |
| English-based | |
| Phonetic | |
| Alphabets | |
| Translate to | 1234 maikro . . . |
| Alternative | |
| Pronunciation | |
| Corresponding | 00300400400117 |
| Translation | 205C0E700002A0 |
| Index | 2B00004F04304E |
| | 03E05000003C04 |
| | 800004F04304E0 |
| | 3E05000003D049 |
| | 00004F04304E03 |
| | E0510000250260 |
| | 0004B03E04E000 |

As an example, there are many Chinese characters that have more than one pronunciation, and a correct alternative pronunciation must be selected according to the context. Therefore, after the original text has been converted from words into corresponding phonetic alphabets, the translating module 3 would further correct some Chinese character codes to their alternative pronunciation according to the context thereof. To do so, the translating module 3 would first search an alternative pronunciation wordbank built in the stock information computing system. When a Chinese character code is found as having been defined in the alternative pronunciation wordbank, the translating module 3 would further search the alternative pronunciation wordbank for a three-word phrase containing that Chinese character code and the words immediately before and after it in the text stock information, so as to make necessary correction of the phonetic alphabets for that Chinese character code or to translate its pronunciation into some other dialect, such as Taiwanese.

Moreover, the sound file databank may be shared among different systems of mobile apparatus using an expanded memory card as the storage device thereof. That is, once the sound files are downloaded, they may be shared by different systems of mobile apparatus for the purpose of broadcasting. In this manner, a large volume of memory and a large amount of downloading cost can be saved, and the need of voice broadcasting may be primarily solved before the mobile apparatus, including cell phones, could be widely provided with the TTS (Text to Speech) function. Since the present system provides a coding method designed to translate text into phonetic alphabets, the sound files provided by the system include not only the Mandarin (or official language) version, but also Taiwanese and Hakka (or dialect language systems) versions. After different sound files have been recorded and necessary conversion to a desired version of sound file wordbank has been done, the user may freely select a desired language for broadcasting.

When it is desired to receive a voice stock information over a mobile apparatus, the data transmitted to the mobile apparatus must be a processed low bit-rate sequence. That is why the above procedures must be executed. There are at least 30,000 characters included in general word character codes. After deducting the characters pronounced in an alternative pronunciation from these 30,000 characters, there are only 1239 mono-sound codes. It is possible to translate the word character codes into phonetic-alphabet-based mono-sound codes and then form the mono-sound code sequence. With the method of the present invention, it is possible to transmit and broadcast voice data via the data band of the Bearer, and to use the transmission of mono-sound codes to replace the direct transmission of data processed via PCM or other voice compressing and coding technique to thereby largely reduce the transmission bit rate. Moreover, by using the mono-sound code sequence to replace a large quantity of word character codes to serve as the index, it is possible to increase the efficiency in searching and broadcasting. In brief, the method of the present invention enables a mobile apparatus to playback real-time voice stock information, and thereby effectively helps the mobile apparatus users who are not convenient to watch the screen of the mobile apparatus over a long time to read the real-time text stock information.

What is claimed is:

1. A method of providing voice stock information via mobile apparatus, in which real-time stock information is displayed and broadcasted at the mobile apparatus via a Bearer (mobile data network) comprising the provision of:
an HTTP server module in a stock information computing system at a server end for downloading required modules, a mono-sound file wordbank, real-time stock data, and a mono-sound code sequence to a mobile apparatus;
a data receiver module, which is downloaded and installed on a mobile apparatus at a receiving end for connecting to said HTTP server module to receive real-time stock information;
a translating module in said stock information computing system at the server end for translating the stock information into mono-sound codes, which are transmitted to the mobile apparatus at the receiving end for broadcasting; and
a playback module, which is downloaded and installed on the mobile apparatus at the receiving end for retrieving mono-sound files corresponding to said mono-sound codes of the received stock information, and reducing the mono-sound files to analogue signals using an A/D converter built in the mobile apparatus to thereby drive a line out of a speaker or an earphone on the mobile apparatus;
said HTTP server module being automatically connected to the mobile apparatus when a user of the mobile apparatus is remotely connected to the stock information computing system for the first time, and downloading and installing said data receiver module, said playback module, said mono-sound file wordbank, and said mono-sound codes on the mobile apparatus to complete a standard installing procedure in an OTA (over the air) mode;
said data receiver module installed on the mobile apparatus end automatically connecting to said HTTP server module for said HTTP server module to download real-time stock data;
said translating module provided at the server end translating the stock data to be broadcasted into a smooth mono-sound code sequence for broadcasting; and
said data receiver module and said playback module provided at the mobile apparatus end corresponding the mono-sound code sequence of the received stock data to the mono-sound codes and the mono-sound file wordbank installed on the mobile apparatus end to enable broadcasting of the received stock data in voice.

2. The method of providing voice stock information via mobile apparatus as claimed in claim 1, wherein said HTTP server module adopts the standard communication protocol established by W3C Forum as a basic transmission platform to achieve a compatibility of the transport layer.

3. The method of providing voice stock information via mobile apparatus as claimed in claim 1, wherein said HTTP server module is connected via the Ethernet or a wide area network (WAN) interface to an existing GGSN (Gateway of Global Service Network) interface of a wireless local area network or a bearer.

4. The method of providing voice stock information via mobile apparatus as claimed in claim 1, wherein said HTTP server module allows a mobile apparatus user to control and designate desired stock codes and trigger conditions, and transmits to the mobile apparatus at the user end only the information or data meeting the user designated stock codes and trigger conditions without the need of transmitting the whole stock information.

5. The method of providing voice stock information via mobile apparatus as claimed in claim 1, wherein said HTTP server module, said data receiver module, and said translating module provide the function of transmitting and displaying real-time graphic and text stock information via the bearer, and the function of transmitting and broadcasting voice stock information and data using the same data band and session.

6. The method of providing voice stock information via mobile apparatus as claimed in claim 1, wherein said HTTP server module is connected via the Ethernet or a wide area network (WAN) interface to the GGSN (Gateway of Global Service Network) of a WLAN, including 802.11a, 802.11b, and 802.11g, or a bearer, including but not limited to GSM, PDC, CDPD, CDMA, TDMA, PHS, DECT, GPRS, and 3G, for the mobile apparatus, such as a cell phone or a mobile digital personal assistant (PDA), to receive the stock information.

7. The method of providing voice stock information via mobile apparatus as claimed in claim 1, wherein said mono-sound file wordbank, said playback module, and said data receiver module being downloaded when a user is first connected to said HTTP server module are installed on a flash memory of the mobile apparatus at the user end.

8. The method of providing voice stock information via mobile apparatus as claimed in claim 1, wherein said translating module reads stock data stored in a real-time price databank in a character code format via said remote stock information computing system, and translates the read stock data in two stages, namely, translating the read stock data into corresponding word character codes, and locating phonetic-alphabet-based mono-sound codes according to the character codes to form the mono-sound code sequence for broadcasting in a complete sentence at the mobile apparatus at the user end.

9. The method of providing voice stock information via mobile apparatus as claimed in claim 1, wherein said translating module includes an interface for actively reporting back based on user-designated trigger conditions, so that a user end may control and designate desired trigger conditions, such as changes in price and quantity, notice of current price, and broadcasted messages, and a mono-sound code sequence is actively created and transmitted to the mobile apparatus for broadcasting when the user-designated trigger conditions exist.

10. The method of providing voice stock information via mobile apparatus as claimed in claim 1, wherein said playback module installed on the mobile apparatus end analyzes the received mono-sound code sequence, and searches the mono-sound file wordbank for voice samples corresponding to individual mono-sound codes; said voice samples being downloaded and stored in a record management system (RMS) of the mobile apparatus when said playback module is first downloaded and installed; said playback module searching the RMS for the mono-sound files corresponding to the mono-sound codes, reading sound bit data stored in the mono-sound files and encoded using PCM (pulse code modulation) format, and reducing the sound bit data to analogue signals via an A/D converter built in the mobile apparatus to thereby drive a line out of a speaker or an earphone on the mobile apparatus.

11. The method of providing voice stock information via mobile apparatus as claimed in claim 1, wherein said translating module uses the client-server architecture to translate any real-time stock data one time for more than one user to connect to the server at the same time to conveniently share the stock information.
